(19) United States
(12) Patent Application Publication
(10) Pub. No.: US 2024/0365147 A1
(43) Pub. Date: Oct. 31, 2024

(54) METHODS AND APPARATUS OF MACHINE LEARNING BASED LINK RECOVERY

(71) Applicant: GUANGDONG OPPO MOBILE TELECOMMUNICATIONS CORP., LTD., Dongguan (CN)

(72) Inventor: Li GUO, Allen, TX (US)

(73) Assignee: GUANGDONG OPPO MOBILE TELECOMMUNICATIONS CORP., LTD., Dongguan (CN)

(21) Appl. No.: 18/769,304

(22) Filed: Jul. 10, 2024

Related U.S. Application Data
(63) Continuation of application No. PCT/IB2023/050228, filed on Jan. 10, 2023.
(60) Provisional application No. 63/298,034, filed on Jan. 10, 2022.

(51) Int. Cl. H04W 24/08

(52) U.S. Cl. CPC H04W 24/08

(57) ABSTRACT

Methods and systems for enabling a terminal device to perform a link recovery process are provided. In some embodiments, the method includes (1) receiving, by the terminal device, a set of Channel State Information Reference Signal (CSI-RS) resources for a beam failure detection; (2) receiving, by the terminal device, configuration information of a first neural network for the beam failure detection; (3) performing, by the terminal device, a measurement on the set of CSI-RS resources; and (4) generating, by the terminal device, a beam failure detection result by applying the first neural network on a result of the measurement on the set of CSI-RS resources.

### CROSS-REFERENCE TO RELATED APPLICATION(S)

This application is a continuation of International Application No. PCT/IB2023/050228, filed on Jan. 10, 2023, which claims priority to U.S. Provisional Patent Application Ser. No. 63/298,034, filed Jan. 10, 2022. The disclosures of the aforementioned applications are hereby incorporated by reference in their entireties.

### TECHNICAL FIELD

The present disclosure relates to beam failure detection and beam/link recovery. More specifically, systems and methods for detecting beam failure and determining new candidate beam reference signal (RS) based on machine learning methods are provided.

### BACKGROUND

New Radio (NR) and fifth generation (5G) communication systems support link recovery (or beam failure recovery) function. Conventional methods for link recovery do not consider all the factors in complicated cellular communication environments. For example, the conventional methods simply assume that a beam failure only happens when a hypothetical Block Error Rate (BLER) is larger than a threshold consecutively for a given time duration. However, the hypothetical BLER calculated based on a Layer-1 (L1) measurement generally has a large variation due to estimation noise and interference. More particularly, in conventional methods, new candidate beam RS is determined based on an L1-RSRP measurement. However, due to noise and interference reasons as discussed above, using the L1-RSRP measurement does not provide a satisfying result in various communication environments. Therefore, improved systems and methods that can address the foregoing issues are desirable and beneficial.

### SUMMARY

The present disclosure is related to systems and methods for enabling NR systems to perform a beam failure recovery function in one component carrier (CC). A terminal device (or UE) can be requested to operate the beam failure recovery function based on one or more machine learning mechanisms.

More particularly, the terminal device can be provided with a set of beam failure detection reference signals (RSs). The terminal device can be requested to apply a first neural network (or a machine learning module) on the beam failure detection RSs provided to the terminal device, so as to detect a beam failure of the CC.

The terminal device can be provided with a set of candidate beam RSs. The terminal device can be requested to apply a second neural network (or a machine learning module) on the candidate beam RSs so as to obtain a new candidate beam RS. When the terminal device declares a beam failure for the CC through a calculation of the first neural network, the terminal device can report the beam failure for that CC to a base station (or gNB). The terminal device can also report the ID of the new candidate beam RS determined through the second neural network to the base station.

In some embodiments, the terminal device can be requested to apply a second neural network on both beam failure detection RSs and candidate beam RSs to determine a new candidate beam RS. Advantages of the present technology include that current beams in use that have beam failure can be considered in determining new candidate beam RSs. Therefore, the present methods avoids situations where a failed beam is selected as a new candidate beam RS.

In some embodiments, a configuration of the first neural network can be provided by the base station to the terminal device. In some embodiments, the configuration of the first neural network can be calculated by the terminal device. In one example, the base station can first send assistance information to the terminal device and then the terminal device can calculate the configuration of the first neural network based on the assistance information provided by the base station.

The proposed methods support the NR system and use machine learning methods to detect beam failures and to determine new candidate beam RS. The accuracy of beam failure detection is thus significantly improved. The accuracy of determining suitable or the best new candidate beam RS can also be significantly improved. In addition, the present methods can improve an operation performance of the beam failure recovery function in NR systems (e.g., in frequency range 2, FR2). As a result, the overall system efficiency of NR systems in FR2 can be significantly improved.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic block diagram of a terminal device in accordance with one or more implementations of the present disclosure.

FIG. 3 is a flowchart of a method in accordance with one or more implementations of the present disclosure.

FIG. 4 is a flowchart of a method in accordance with one or more implementations of the present disclosure.

### DESCRIPTION OF EMBODIMENTS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

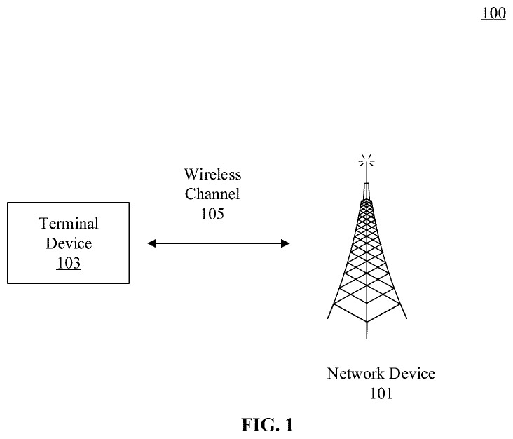

FIG. 1 is a schematic diagram of a wireless communication system 100 in accordance with one or more implementations of the present disclosure. The wireless communication system 100 can implement the methods discussed herein for beam failure detection and beam/link recovery. As shown in FIG. 1, the wireless communications system 100 includes a network device (or base station/cell) 101.

Examples of the network device 101 include a base transceiver station (BTS), a NodeB (NB), an evolved Node B (eNB or eNodeB), a Next Generation NodeB (gNB or gNode B), a Wireless Fidelity (Wi-Fi) access point (AP), etc. In some embodiments, the network device 101 can include a relay station, an access point, an in-vehicle device, a wearable device, and the like. The network device 101 can include wireless connection devices for communication networks such as: a Global System for Mobile Communications (GSM) network, a Code Division Multiple Access (CDMA) network, a Wideband CDMA (WCDMA) network, an LTE network, a cloud radio access network (CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (PLMN), or the like. A 5G system or network can be referred to as an NR system or network.

In FIG. 1, the wireless communications system 100 also includes a terminal device 103. The terminal device 103 can be an end-user device configured to facilitate wireless communication. The terminal device 103 can be configured to wirelessly connect to the network device 101 (via, e.g., via a wireless channel 105) according to one or more corresponding communication protocols/standards.

The terminal device 103 may be mobile or fixed. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only one network device 101 and one terminal device 103 in the wireless communications system 100. However, in some instances, the wireless communications system 100 can include additional network device 101 and/or terminal device 103.

The terminal device 103 can be requested (e.g., by the network device 101) to operate a beam failure recovery function based on one or more machine learning mechanisms. For example, the terminal device 103 can be provided (e.g., by the network device 101) with a set of beam failure detection RSs. The terminal device 103 can be requested to apply a first neural network (or a machine learning module) on the provided beam failure detection RSs, so as to detect a beam failure of a carrier component (CC).

The terminal device 103 can be provided with a set of candidate beam RSs. The terminal device 103 can be requested to apply a second neural network (or a machine learning module) on the candidate beam RSs so as to obtain a new candidate beam RS. When the terminal device 103 declares a beam failure for the CC through a calculation of the first neural network, the terminal device can report the beam failure for that CC to the network device 101. The terminal device 103 can also report the ID of the new candidate beam RS determined through the second neural network to the network device 101. In some embodiments, the terminal device 103 can be requested to apply the second neural network on both beam failure detection RSs and candidate beam RSs for determining a new candidate beam RS.

In some embodiments, a configuration of the first neural network can be provided by the network device 101 to the terminal device 103. In some embodiments, the configuration of the first neural network can be calculated by the terminal device 103. In some examples, the network device 101 first sends assistance information to the terminal device 103 and then the terminal device 103 can calculate the configuration of the first neural network based on the assistance information provided by the network device 101.

In some embodiments, the terminal device 103 can be provided with configuration information for a set of RSs for beam failure detection. The configuration information includes one or more Channel State Information Reference Signal (CSI-RS) resources.

In some embodiments, the terminal device 103 can be provided with a configuration of a first neural network for beam failure detection. The terminal device 103 can be requested to measure the CSI-RS resources in the set of CSI-RS resources for beam failure detection. The terminal device 103 can be requested to apply the first neural network on the measurement metrics measured from the CSI-RS resources contained in the set of RSs for beam failure detection.

In some embodiments, the terminal device 103 can be requested to apply the first neural network on one or more of the following measurement results measured from the CSI-RS resources contain in the set of RSs for beam failure detection to declare beam failure:
(1) L1-RSRP (Reference Signal Received Power) measured from the CSI-RS resources contained in the set of RSs for beam failure detection.
(2) L1-RSRQ (Reference Signal Received Quality) measured from the CSI-RS resources contained in the set of RSs for beam failure detection.
(3) L1-RSSI (Received Signal Strength Indication) measured from the CSI-RS resources contained in the set of RSs for beam failure detection.
(4) L1-SINR (Signal to Interference Noise Ratio) measured from the CSI-RS resources contained in the set of RSs for beam failure detection.
(5) BLER (Block Error Rate) measured from the CSI-RS resources contained in the set of RSs for beam failure detection.
(6) A time stamp of each measurement result measured from the CSI-RS resources contained in the set of RSs for beam failure detection.
(7) L1-RSRP measured from a Physical Downlink Control Channel (PDCCH) transmission.
(8) L1-RSRQ measured from the PDCCH transmission.
(9) L1-SINR measured from the PDCCH transmission.
(10) The BLER measured from the PDCCH transmission.

In some embodiments, the configuration of the first neural network can be provided by the network device 101 to the terminal device 103. The terminal device 103 can apply the first neural network according to the configuration provided by the network device 101. In another example, the configuration of the first neural network can be obtained by the terminal device 103. The terminal device 103 can calculate the configuration of the first neural network based on: previous measurement results, beam failure status of the link between the network device 101 and the terminal device 103, system configuration information, etc.

In some examples, the network device 101 can provide some assistance/configuration information of the first neural network to the terminal device 103 for calculating the configuration of the first neural network. In some embodiments, the current status of a communication link between the terminal device 103 and the network device 101 can also be considered for the foregoing calculation.

In some embodiments, the configuration of first neural network can be obtained by a learning procedure based on the terminal device's 103 measurement results on CSI-RS resources for beam failure detection and the state of the link between the terminal device 103 and the network device 101. In some cases, the state of the link can be categorized to two states: “non-failed” or “failed.” The state of the link and the corresponding measurement results on CSI-RS resources for beam failure detection can be inputted into the learning procedure to obtain the configuration of the first neural network. The learning procedure can be conducted by the terminal device 103. The terminal device 103 can use its measurement results and the link state to train the configuration of the first neural network.

In some embodiments, the learning procedure can be performed by the network device 101. The network device 101 can first collect the measurement results of CSI-RS resources for beam failure detection and also the corresponding states of links from one or more terminal devices 103. Then the network device 101 can train the configuration of the first neural network based on the reported measurement results and corresponding state of link from the terminal device(s) 103.

In some implementations, the terminal device 103 can be configured with beam failure recovery (or called link recovery) function. The terminal device 103 can be provided with a configuration of a first set of RSs for beam failure detection, which can contain one or more CSI-RS resources. The terminal device 103 can be provided with a configuration of a second set of RSs for candidate beam RS, which can contain one or more CSI-RS resources and/or SSBs (Synchronization Signal and Physical Broadcast Channel Blocks). The terminal device 103 can be provided with a configuration of a second neural network for determining new candidate RS. The terminal device 103 can be requested to apply the second neural network on the measurement results of the CSI-RS resources and/or SSBs in the second set of RSs for candidate beam RS to determine one RS from the CSI-RS resources and/or SSBs contained in the second set of RSs for candidate beam RS.

In some embodiments, the terminal device 103 can be requested to apply the second neural network on the measurement results of the CSI-RS resources and/or SSBs in the second set of RSs for candidate beam RS to determine one RS from the CSI-RS resources and/or SSBs contained in the second set of RSs for candidate beam RS. In one example, the terminal device 103 can be requested to apply the second neural network on the measurement results of the CSI-RS resources and/or SSBs in the second set of RSs for candidate beam RS and the measurement results on CSI-RS resources contained in the first set to determine one RS from the CSI-RS resources and/or SSBs contained in the second set of RSs for candidate beam RS. The benefit of this example is that the failed beams are taken into consideration when determining new candidate beams, which effectively avoid an actually-failed beam to be re-selected as a new candidate beam RS.

In some embodiments, the terminal device 103 can be requested to apply the second neural network on the measurement results of the CSI-RS resources and/or SSBs in the second set of RSs for candidate beam RS and the measurement results on CSI-RS resources contained in the first set and the measurement results on PDCCH transmission to determine one RS from the CSI-RS resources and/or SSBs contained in the second set of RSs for candidate beam RS. The benefit of this example is that the actual link quality of the PDCCH is taken into consideration when determining a new candidate beam RS.

In some implementations, the terminal device can be requested to apply the second neural network on one or more of the following measurement results for determining one CSI-RS resource and/or SSB from the CSI-RS resources and/or SSBs contained in the second set as a new candidate beam RS for beam failure recovery:
(1) L1-RSRP measured from the CSI-RS resources and SSBs contained in the second set of RSs for candidate beam RS.
(2) L1-RSRQ measured from the CSI-RS resources and SSBs contained in the second set of RSs for candidate beam RS.
(3) L1-RSSI measured from the CSI-RS resources and SSBs contained in the second set of RSs for candidate beam RS.
(4) L1-SINR measured from the CSI-RS resources and SSBs contained in the second set of RSs for candidate beam RS.
(5) Hypothetical BLER measured from the CSI-RS resources and SSBs contained in the second set of RSs for candidate beam RS.
(6) A time stamp of each measurement result measured from the CSI-RS resources and/SSBs contained in the second set of RSs for candidate beam RS.
(7) L1-RSRP measured from the CSI-RS resources contained in the set of RSs for beam failure detection.
(8) L1-RSRQ measured from the CSI-RS resources contained in the set of RSs for beam failure detection.
(9) L1-RSSI measured from the CSI-RS resources contained in the set of RSs for beam failure detection.
(10) L1-SINR measured from the CSI-RS resources contained in the set of RSs for beam failure detection.
(11) Heretical BLER measured from the CSI-RS resources contained in the set of RSs for beam failure detection.
(12) The time stamp of each measurement result measured from the CSI-RS resources contained in the set of RSs for beam failure detection.
(13) L1-RSRP measured from a PDCCH transmission.
(14) L1-RSRQ measured from the PDCCH transmission.
(15) L1-SINR measured from the PDCCH transmission.
(16) BLER measured from the PDCCH transmission.

In some examples, the configuration of the second neural network can be provided by the network device 101 to the terminal device 103 and the terminal device 103 can apply the second neural network according to the configuration provided by the network device 101.

In other examples, the configuration of the second neural network can be obtained by the terminal device 103. The terminal device 103 can calculate the configuration of the second neural network based on (1) CSI-RS resource or SSB that is pre-determined to be a new candidate beam RS, (2) previous measurement results on RS for candidate beam, (3) previous measurement results on beam failure detection RS and beam failure status of the link between the network device 101 and the terminal device 103; and (4) the system configuration information.

In some embodiments, the configuration of second neural network can be obtained by learning procedure based on (i) the terminal device 103 measurement results on CSI-RS resources and/or SSBs for candidate beam RS, (ii) measurement results on CSI-RS resources for beam failure detection and (iii) the state of the link between the terminal device 103 and the network device 101. The state of the link can be categorized to two states: “non-failed” or “failed.” In some embodiments, inputs for the learning procedure can include (a) the state of the link, (b) corresponding measurement results on CSI-RS resources for beam failure detection, (c) corresponding measurements on CSI-RS resources and/or SSBs for candidate beam RS, and (d) some CSI-RS resource or SSB that is pre-determined to be a new candidate beam RS.

This learning procedure can be conducted by the terminal device 103 and the terminal device 103 can use its measurement results and the link state to train the configuration of the second neural network.

The learning procedure can be performed by the network device 101. The network device 101 can collect the measurement results of CSI-RS resources for beam failure detection, some CSI-RS resource or SSB that is pre-determined to be a new candidate beam RS and measurement results of CSI-RS resources and/or SSBs for candidate beam RS from one or more terminal devices 103 and also the corresponding state of link from one or more terminal devices 103. Then the network device 101 can train the configuration of the second neural network based on the reported measurement results, corresponding state of link and corresponding CSI-RS resource or SSB that is pre-determined to be a new candidate beam RS from the terminal device 103.

In some embodiments, the terminal device 103 can be configured to perform beam failure recovery for “K>1” CCs. The terminal device 103 can be provided with configuration of a third neural network and the terminal device 103 can be requested to use the third neural network to predict the beam failure of a first CC according to the measurement results on a second CC.

In some examples, the terminal device 103 can be provided with a set of beam failure detection RSs for the second CC and the terminal device 103 can be requested to measure those beam failure detection RSs. Then the terminal device 103 can apply the third neural network on the measurement results of the beam failure detection RSs of the second CC to calculate the beam failure status of the first CC.

In one example, the terminal device 103 can apply the third neural network on the beam failure states of one or more CCs to calculate the beam failure of the first CC. In one example, the terminal device 103 can apply the third neural network on the beam failure state of one or more CCs and the measurement results of beam failure detection RSs of one or more CCs to calculate the beam failure of the first CC. The benefits of the foreign approaches include that the correlation between different CCs for the same network device 101 and terminal device 103 can be utilized to predict the beam failure of different CCs. As a result, the overhead of beam failure detection RS can be significantly reduced and thus improve overall efficiency.

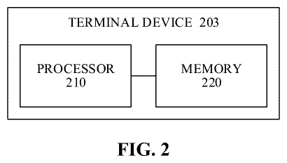

FIG. 2 is a schematic block diagram of a terminal device 203 (e.g., which can implement the methods discussed herein) in accordance with one or more implementations of the present disclosure. As shown, the terminal device 203 includes a processing unit 210 (e.g., a DSP, a CPU, a GPU, etc.) and a memory 220. The processing unit 210 can be configured to implement instructions that correspond to the methods discussed herein and/or other aspects of the implementations described above. It should be understood that the processor 210 in the implementations of this technology may be an integrated circuit chip and has a signal processing capability. During implementation, the steps in the foregoing method may be implemented by using an integrated logic circuit of hardware in the processor 210 or an instruction in the form of software. The processor 210 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 210 may be a microprocessor, or the processor 210 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 220, and the processor 210 reads information in the memory 220 and completes the steps in the foregoing methods in combination with the hardware thereof.

It may be understood that the memory 220 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

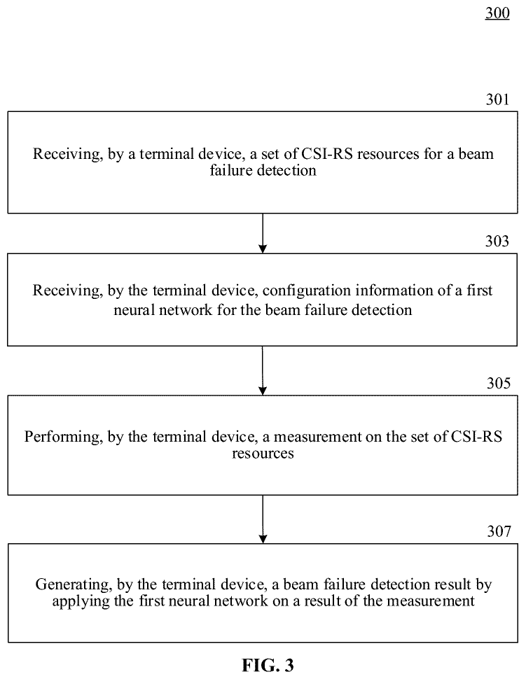

FIG. 3 is a flowchart of a method 300 in accordance with one or more implementations of the present disclosure. The method 300 can be implemented by a system (such as the wireless communications system 100). For example, the method 300 may also be implemented by the terminal device 103.

The method 300 includes, at block 301, receiving, by the terminal device, a set of Channel State Information Reference Signal (CSI-RS) resources for a beam failure detection. At block 303, the method 300 continues by receiving, by the terminal device, configuration information of a first neural network for the beam failure detection.

At block 305, the method 300 continues by performing, by the terminal device, a measurement on the set of CSI-RS resources. At block 307, the method 300 continues by generating, by the terminal device, a beam failure detection result by applying the first neural network on a result of the measurement on the set of CSI-RS resources. In some embodiments, the beam failure detection is for one carrier component (CC).

In some embodiments, the first neural network is configured to consider one or more following measurements when generating the beam failure detection result: L1-RSRP (Reference Signal Received Power) measured from the set of CSI-RS resources, L1-RSRQ (Reference Signal Received Quality) measured from the set of CSI-RS resources, and L1-RSSI (Received Signal Strength Indication) measured from the set of CSI-RS resources.

In some embodiments, the first neural network is configured to consider one or more following measurements when generating the beam failure detection result: L1-SINR (Signal to Interference Noise Ratio) measured from the set of CSI-RS resources, a time stamp of the measurement on the set of CSI-RS resources, and BLER (Block Error Rate) measured from the set of CSI-RS resources.

In some embodiments, the first neural network is configured to consider one or more following measurements when generating the beam failure detection result: L1-RSRP measured from a Physical Downlink Control Channel (PDCCH) transmission and L1-RSRQ measured from the PDCCH transmission. In some embodiments, the first neural network is configured to consider one or more following measurements when generating the beam failure detection result: L1-SINR measured from a PDCCH transmission and BLER measured from the PDCCH transmission.

In some embodiments, the configuration information is received from a network device, and wherein the configuration information includes a current status of a communication link between the terminal device and the network device. The current status of the communication link includes a first indicator “failed” or a second indicator “non-failed.”

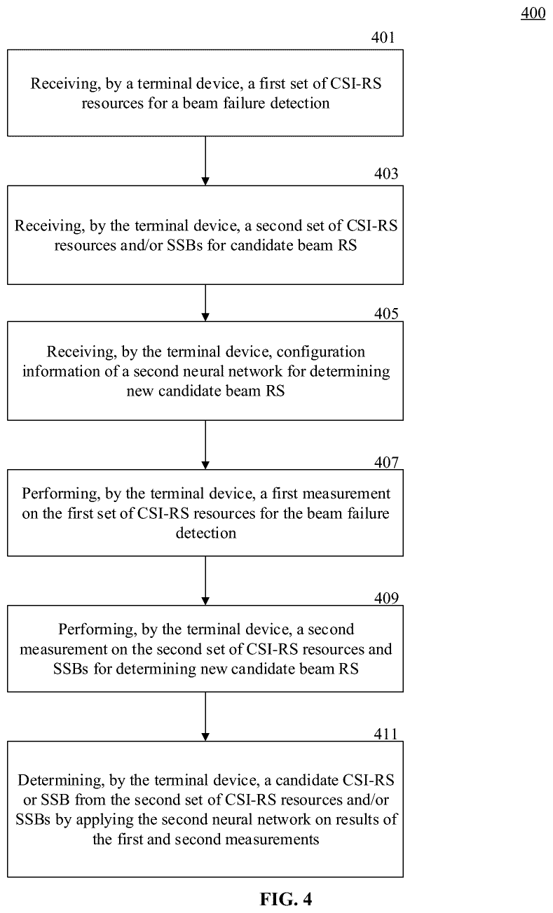

FIG. 4 is a flowchart of a method 400 in accordance with one or more implementations of the present disclosure. The method 400 can be implemented by a system (such as the wireless communications system 100). For example, the method 400 may also be implemented by the terminal device 103.

The method 400 includes, at block 401, receiving, by the terminal device, a first set of Channel State Information Reference Signal (CSI-RS) resources for a beam failure detection. At block 403, the method 400 continues by receiving, by the terminal device, a second set of CSI-RS resources and Synchronization Signal and Physical Broadcast Channel Blocks (SSBs) for candidate beam RS.

At block 405, the method 400 continues by receiving, by the terminal device, configuration information of a second neural network for determining new candidate beam RS. At block 407, the method 400 continues by performing, by the terminal device, a first measurement on the first set of CSI-RS resources for the beam failure detection.

At block 409, the method 400 continues by performing, by the terminal device, a second measurement on the second set of CSI-RS resources and SSBs for determining new candidate beam RS. At block 4011, the method 400 continues by determining, by the terminal device, a candidate CSI-RS or SSB from the second set of CSI-RS resources and SSBs by applying the second neural network on results of the first and second measurements.

In some embodiments, the beam failure detection is for one carrier component (CC). In some embodiments, the second neural network is configured to consider one or more following measurements when generating the beam failure detection result: L1-RSRP measured from the second set of CSI-RS resources and SSBs, L1-RSRQ measured from the second set of CSI-RS resources and SSBs, and L1-RSSI measured from the second set of CSI-RS resources and SSBs.

In some embodiments, the second neural network is configured to consider one or more following measurements when generating the beam failure detection result: L1-SINR measured from the second set of CSI-RS resources and SSBs, a time stamp of the second measurement, or BLER measured from the second set of CSI-RS resources and SSBs.

In some embodiments, the second neural network is configured to consider one or more following measurements when generating the beam failure detection result: L1-RSRP measured from a PDCCH transmission or L1-RSRQ measured from the PDCCH transmission. In some embodiments, the second neural network is configured to consider one or more following measurements when generating the beam failure detection result: L1-SINR measured from a PDCCH transmission or BLER measured from the PDCCH transmission.

In some embodiments, the configuration information is received from a network device, and wherein the configuration information includes a current status of a communication link between the terminal device and the network device. In some embodiments, the current status of the communication link includes a first indicator “failed” or a second indicator “non-failed.”

### ADDITIONAL CONSIDERATIONS

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1. A method for configuring a terminal device for a link recovery, comprising:
receiving, by the terminal device, a set of Channel State Information Reference Signal (CSI-RS) resources for a beam failure detection;
receiving, by the terminal device, configuration information of a first neural network for the beam failure detection;
performing, by the terminal device, a measurement on the set of CSI-RS resources; and
generating, by the terminal device, a beam failure detection result by applying the first neural network on a result of the measurement on the set of CSI-RS resources.

2. The method of claim 1, wherein the beam failure detection is for one carrier component (CC).

3. The method of claim 1, wherein the first neural network is configured to consider one or more following measurements when generating the beam failure detection result: L1-RSRP (Reference Signal Received Power) measured from the set of CSI-RS resources, L1-RSRQ (Reference Signal Received Quality) measured from the set of CSI-RS resources, and L1-RSSI (Received Signal Strength Indication) measured from the set of CSI-RS resources.

4. The method of claim 1, wherein the first neural network is configured to consider one or more following measurements when generating the beam failure detection result: L1-SINR (Signal to Interference Noise Ratio) measured from the set of CSI-RS resources, a time stamp of the measurement on the set of CSI-RS resources, and BLER (Block Error Rate) measured from the set of CSI-RS resources.

5. The method of claim 1, wherein the first neural network is configured to consider one or more following measurements when generating the beam failure detection result: L1-RSRP measured from a Physical Downlink Control Channel (PDCCH) transmission and L1-RSRQ measured from the PDCCH transmission.

6. The method of claim 1, wherein the first neural network is configured to consider one or more following measurements when generating the beam failure detection result: L1-SINR measured from a PDCCH transmission and BLER measured from the PDCCH transmission.

7. The method of claim 1, wherein the configuration information is received from a network device, and wherein the configuration information includes a current status of a communication link between the terminal device and the network device.

8. The method of claim 7, wherein the current status of the communication link includes a first indicator “failed” or a second indicator “non-failed.”

9. A method for configuring a terminal device for a link recovery, comprising:
receiving, by the terminal device, a first set of Channel State Information Reference Signal (CSI-RS) resources for a beam failure detection;
receiving, by the terminal device, a second set of CSI-RS resources and Synchronization Signal and Physical Broadcast Channel Blocks (SSBs) for candidate beam RS;
receiving, by the terminal device, configuration information of a second neural network for determining new candidate beam RS;
performing, by the terminal device, a first measurement on the first set of CSI-RS resources for the beam failure detection;
performing, by the terminal device, a second measurement on the second set of CSI-RS resources and SSBs for determining new candidate beam RS; and
determining, by the terminal device, a candidate CSI-RS or SSB from the second set of CSI-RS resources and SSBs by applying the second neural network on results of the first and second measurements.

10. The method of claim 9, wherein the beam failure detection is for one carrier component (CC).

11. The method of claim 9, wherein the second neural network is configured to consider one or more following measurements when generating the beam failure detection result: L1-RSRP measured from the second set of CSI-RS resources and SSBs, L1-RSRQ measured from the second set of CSI-RS resources and SSBs, and L1-RSSI measured from the second set of CSI-RS resources and SSBs.

12. The method of claim 9, wherein the second neural network is configured to consider one or more following measurements when generating the beam failure detection result: L1-SINR measured from the second set of CSI-RS resources and SSBs, a time stamp of the second measurement, or BLER measured from the second set of CSI-RS resources and SSBs.

13. The method of claim 9, wherein the second neural network is configured to consider one or more following measurements when generating the beam failure detection result: L1-RSRP measured from a PDCCH transmission or L1-RSRQ measured from the PDCCH transmission.

14. The method of claim 9, wherein the second neural network is configured to consider one or more following measurements when generating the beam failure detection result: L1-SINR measured from a PDCCH transmission or BLER measured from the PDCCH transmission.

15. The method of claim 9, wherein the configuration information is received from a network device, and wherein the configuration information includes a current status of a communication link between the terminal device and the network device.

16. The method of claim 15, wherein the current status of the communication link includes a first indicator “failed” or a second indicator “non-failed.”

17. A system comprising:
a processor; and
a memory configured to store instructions, when executed by the processor, to:
receive, by the terminal device, a set of Channel State Information Reference Signal (CSI-RS) resources for a beam failure detection;
receive, by the terminal device, configuration information of a first neural network for the beam failure detection;
performing, by the terminal device, a measurement on the set of CSI-RS resources; and
generate, by the terminal device, a beam failure detection result by applying the first neural network on a result of the measurement on the set of CSI-RS resources.

18. The system of claim 17, wherein the beam failure detection is for one carrier component (CC).

19. The system of claim 17, wherein the first neural network is configured to consider one or more following measurements when generating the beam failure detection result: L1-RSRP measured from the set of CSI-RS resources, L1-RSRQ measured from the set of CSI-RS resources, L1-RSSI measured from the set of CSI-RS resources, L1-SINR measured from the set of CSI-RS resources, a time stamp of the measurement on the set of CSI-RS resources, and BLER measured from the set of CSI-RS resources.

20. The system of claim 17, wherein the first neural network is configured to consider one or more following measurements when generating the beam failure detection result: L1-RSRP measured from a PDCCH transmission, L1-RSRQ measured from the PDCCH transmission, L1-SINR measured from a PDCCH transmission, and BLER measured from the PDCCH transmission.
